(19) United States
(12) Patent Application Publication
(10) Pub. No.: US 2016/0231029 A1
(43) Pub. Date: Aug. 11, 2016

(54) Portable appliance combining water dispenser, refrigerator, microwave, bed tray table and waste containers

(71) Applicant: Hongjun Pan, Lewisville, TX (US)

(72) Inventor: Hongjun Pan, Lewisville, TX (US)

(21) Appl. No.: 14/620,147

(22) Filed: Feb. 11, 2015

(51) Int. Cl. F25B 13/00; A47B 79/00; F24H 1/10; H05B 6/64; F24H 1/00; A47B 23/04; H05B 6/80

(52) U.S. Cl. CPC F25B 13/00; A47B 23/04; A47B 79/00; H05B 6/80; H05B 6/6435; F24H 1/0072; F24H 1/101

(57) ABSTRACT

A new portable multiple function appliance is presented for the people who have to stay in bed for prolong time or their rest of life due to various reasons to take care most of their daily life needs by themselves with one functional arm and hand; such portable multiple function appliance combines a hot and cold water dispenser, a refrigerator, a microwave oven, a central operation unit, a bed tray table with a lamp, three waste containers and a moving cart. This appliance is placed besides a bed, the people in the beds can operate the appliance for their daily life needs, i.e. get the food out the refrigerator, put it into the microwave oven to warm it, get hot or cold water, make a cup of coffee or tea, take medicine or clean themselves by changing diapers and wipe themselves, put the wastes into waste containers, work in the bed, type documents in a computer or surf the internet. This will dramatically reduce the family members or healthcare providers' work load and stress. The 3-in-1 combination of the water dispenser, the refrigerator and the microwave oven can also be placed in regular offices and apartments for personal use.

### REFERENCES

### U.S. Patent Documents

| | | |
|---|---|---|
| 2011300272 | December 2011 | Smario |
| D598699 | August 2009 | Patterson |
| D595316 | June 2009 | Farah |
| D368484 | April 1996 | Bone |
| D368482 | April 1996 | Bone |
| 4,958,055 | September 1990 | Shim |
| 4,880,954 | November 1989 | Bennett et al. |
| D286882 | November 1986 | Hong |
| T973013 | August 1978 | Ferrara, et al. |

### Foreign Patent Documents

| | | | |
|---|---|---|---|
| RU | 2007144534 | July 2007 | Partala |
| CN | 1731055 | February 2006 | Cao |
| CN | 1834558 | September 2006 | Sun |
| KR | 20050110230 | November 2005 | Seong |
| KR | 20040070414 | August 2004 | Kim |
| KR | 20010010608 | June 2001 | Song |
| CN | 1316638 | October 2001 | Wang |
| DE | 19825857 | December 1999 | Beeh |
| JP | 3258887 | August 1997 | Sone |
| KR | 20050110230 | November 2005 | Seong |
| RU | 2080746 | May 1997 | Zhilkov et al. |

### FIELD OF THE INVENTION

The present invention relates to the daily life appliance and more specifically to the refrigerator, the microwave oven, the water dispenser, the coffee maker, the bed tray table and the waster container.

### BACKGROUND OF THE INVENTION

A lot of people (defined as patients in this entire patent document) in the world have to stay in the beds due to handicapped, injury and illness (for example, surgery, stroke, broken legs or paralyzed due to spinal cord damage, etc.) for prolong period time of treatment and recovery or for the rest of their lives, they may need frequently attentions or services such as bringing them food, water, medicine and helping them urine and having a bowl movement, take away their wastes, some of the medicines have to be kept in a refrigerator and are difficult to be reached by the patients. However, other family members may have to work or have other duties and have to leave the patients for substantially long time, hiring a healthcare provider to take care of those patients for substantially long time every day will be expensive and may not be affordable for the families; such situation will be difficult for both the families and the patients. However, a great portion of those patients have at least one arm and one hand functioning normally and their physical condition allows them being able to do suitable activities, so it is strongly desirable to invent an easy operation and space saving appliance that the patients can use to take care most of their daily life needs with their one functional arm and hand. None of previous arts listed in the reference section can provide such functionality.

### OBJECTIVE AND SUMMARY OF THE INVENTION

The purpose of the present invention is to provide a portable multiple function appliance which can be used by patients who have to stay in a bed to take care most of their daily life needs. This invention combines a refrigerator, a microwave oven, a hot and cold water dispenser, a bed tray table, three waste containers and a portable moving cart. The refrigerator, the microwave oven, the water dispenser and the bed tray table are operated by the central operation unit which can be operated by one hand, daily life wastes can be stored in different waste containers according to their categories.

### BRIEF DESPCRIPTION OF THE INVENTION

The embodiments of the present invention can be better illustrated by the following drawings.

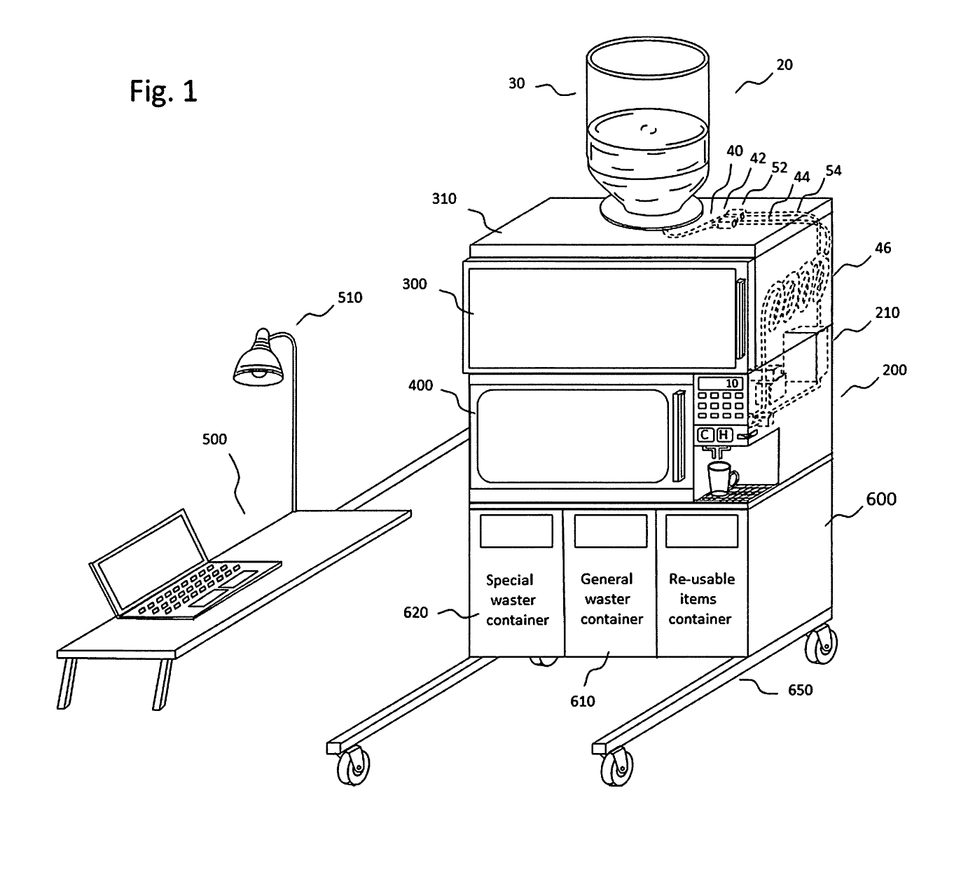

FIG. 1 is the front perspective view of the multiple function appliance showing the structure of the multiple function appliance with each component such as the refrigerator, the microwave oven, the water dispenser, the waste containers, the bed tray table with the lamp, the central operation unit and the portable moving cart.

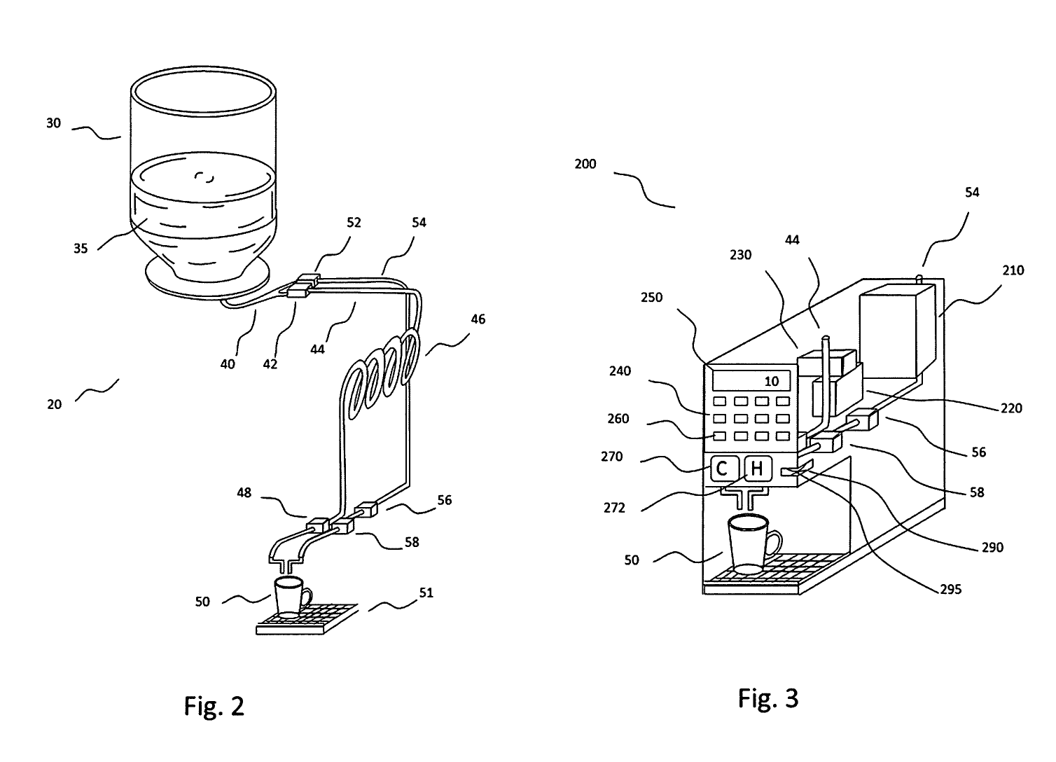

FIG. 2 is the hot and cold water dispenser.

FIG. 3 is the central operation unit.

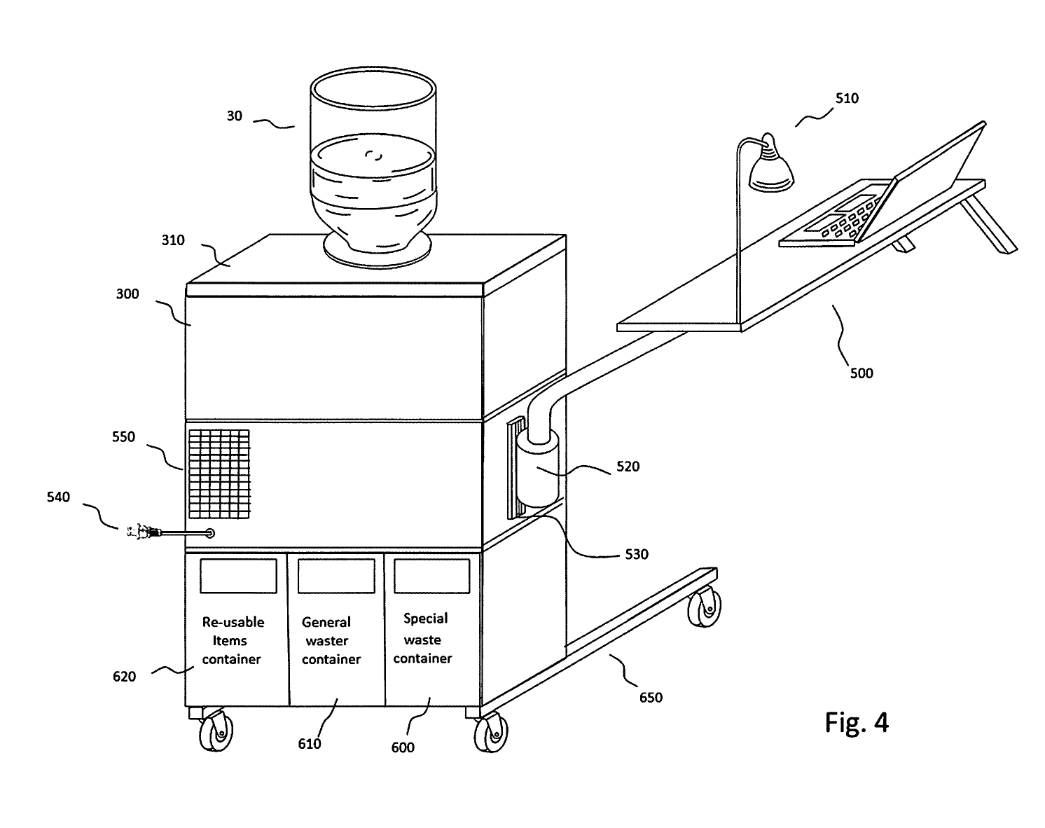

FIG. 4 is the back perspective view of the multiple function appliance showing that the bed tray table with the lamp is mounted on a motor which is attached to the side of the appliance and the bed tray table with the lamp can be rotated by the motor.

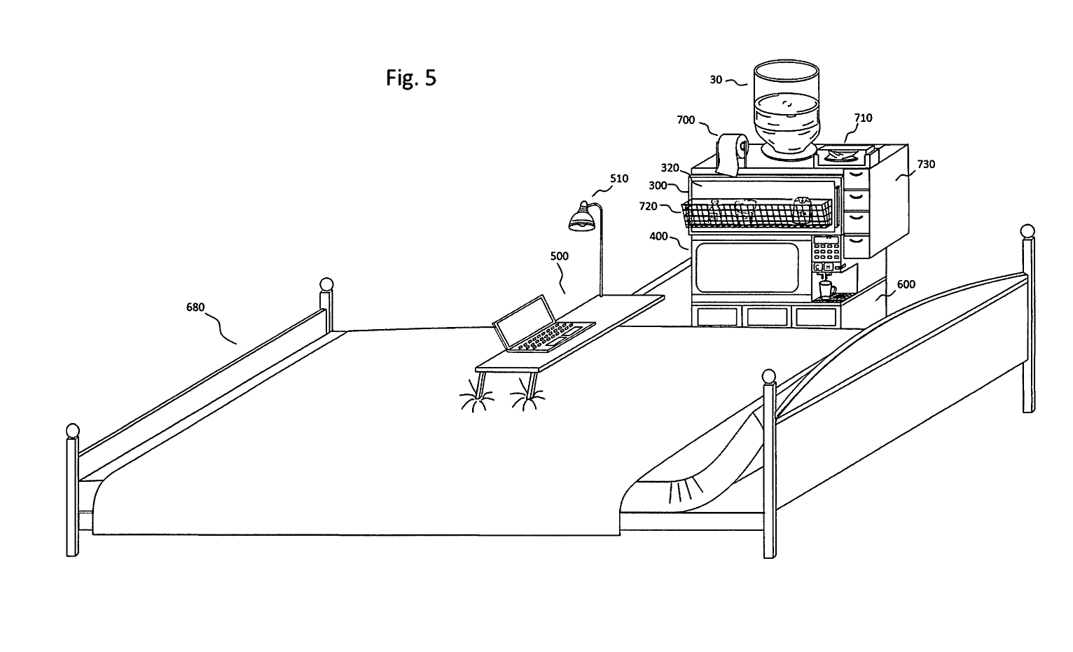

FIG. 5 is the front perspective view of the multiple function appliance with many attachments and is placed besides a bed and can be operated by a patient in the bed.

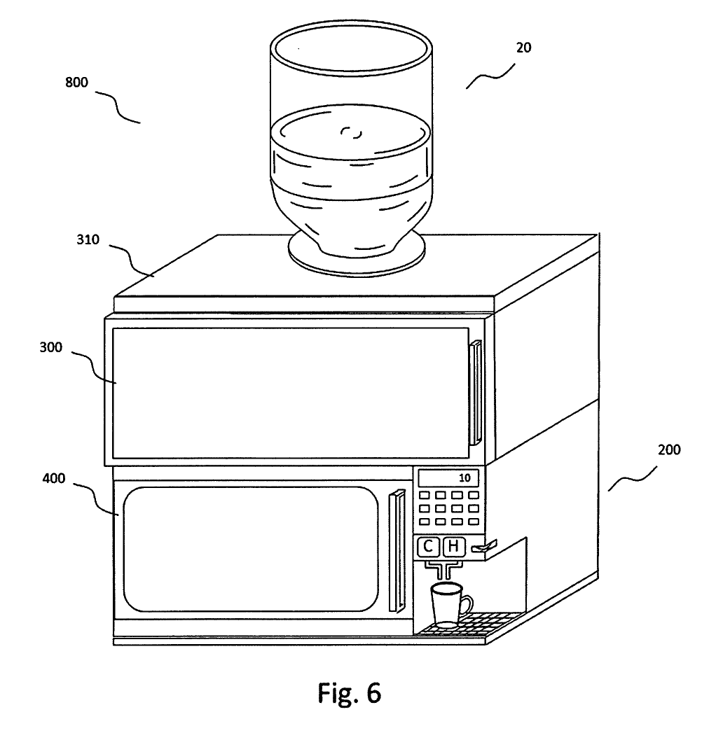

FIG. 6 is the part of this multiple function appliance which combines only the water dispenser, the refrigerator, the microwave oven and the central operation unit. Such combination unit can be placed in an office or an apartment for personal use.

### DETAILED DESCRIPTION OF THE PREFERRED EMBODIMENTS

It will be easier to understand the detail of the embodiments by starting with the detail of the water dispenser 20 in FIG. 2. In the water dispenser 20, the water reservoir 30 holds water 35, the water flows out from the bottom of the water reservoir 30, passes through the Y tube 40 and splits into the cold water line and the hot water line, respectively; the water in cold water line enters the water pump 42, then flows through the tube 44, a section 46 of the tube 44 is coiled which is placed inside of cooling chamber 300 of the refrigerator for cooling the water (shown in dash line in FIG. 1), then the water enters a release valve 48 and reaches the cup 50 which is located at the cup sitting area 51 of the central operation unit 200 (shown in FIG. 3); the water volume inside the coiled tube 46 is enough for one cup. The water in the hot water line enters the water pump 52, then flows through the tube 54, the tube 54 is placed outside of the cooling chamber 300 of the refrigerator, but is still inside of the outer insulation layer of the cooling chamber 300, and the water in tube 54 enters the heating element 56 and the release valve 58, then reaches the cup 50.

Referring to the FIG. 3, the central operation unit 200. The central operation unit 200 contains all electronic and mechanic components for the multiple function appliance 1, those components include a cooing unit 210 for the refrigerator (the cooling unit can be a semiconductor cooling unit or a mechanic cooling unit which compromises a compressor, a heat exchange, a fans, etc.), the microwave oven heating unit (such as a magnetron 220 and a waveguide 230, etc.), a water heating element 56, water release valves 58 and 48, and an operation electronic circuit board with front panel 240, the operation circuit board is responsible for the entire operation of the multiple function appliance 1; an information display window 250 is on the top of the front panel 240, various operation buttons 260 are below the display window 250 and are used to setup the refrigerator temperature, the hot water temperature, the microwave oven power level and running time, and to setup the time schedule to remind the patients in the bed to take food, medicine, sleep and etc., to control the motor to rotate the bed tray table with the lamp and to turn on/off the lamp, one of the buttons may be set as an emergency call button which can call family members or healthcare providers for urgent attention when it is pressed; there are the cold water button 270 and the hot water button 272 on the front panel 240, when the cold water button 270 is pressed, the water pump 42 and the water release valve 48 are activated and cold water is released to the cup 50 located in the cup sitting area 51; when the hot water button 272 is pressed, the water pump 52, the heating element 56 and the water release valve 58 are activated, the hot water with the desired temperature is released to the cup 50. There is a plastic bag opener 280 next to the water release valve 272 and at the side corner of the central operation 200, this plastic bag opener 280 has an open slot 290 with the sharp blaze 295 inside; the patient just holds the plastic bag and slides the edge of the bag through the open slot 290, the sealed bag will be cut by the sharp blaze 295 and contents of the bag can be taken out; the plastic bags include sealed eat-ready food package (such as ramen noodle bags, personal pizza packs, frozen food packs, etc.), coffee bags, cream bags, sugar bags, tea bags, etc..

With the knowledge of the detailed water dispenser 20 and the central operation unit 200, it will be easy to understand the detail of the portable multiple function appliance. Referring FIG. 1, the multiple function appliance 1 combines the water dispenser 20 (shown in FIG. 2), the refrigerator cooling chamber 300, the microwave oven heating chamber 400, the central operation unit 200 (shown in FIG. 3), the bed tray table 500 with the lamp 510, the re-usable dirty item container 600, the general waste container 610, the special waste container 620 and the moving cart 650. The water reservoir 30 is mounted on the top insulation layer 310 of the refrigerator cooling chamber 300, the Y-tube 40, the water pumps 42 and 52 and sections of the tube 44 and 54 (all shown in dash line) are placed inside of the top layer 310 of the cooling chamber 300, the coiled section 46 (shown in dash line) of the tube 44 is inside the cooling chamber 300 to reserve cold water. The microwave oven heating chamber 400 and central operation unit 200 is below the refrigerator cooling chamber 300, the temperature of the cooling chamber 300 is controlled by the cooling unit 210 (shown in dash line), the contents inside the microwave oven heating chamber is heated by the magnetron 220 and the waveguide 230 (both shown in dash line); the bed tray table 500 with the lamp 510 is mounted on a motor 520 which is installed on the side of the appliance 1 shown in FIG. 4 and the bed tray table 500 with the lamp 510 can be rotated by the motor 520, the height of the bed tray table 500 can be adjusted through the mounting rail 530; 540 is the electric power plug and the 550 is the air vent; the rotation of the motor and the lamp can be controlled by the operation buttons 260. The microwave oven heating chamber 400 and the central operation unit 200 are mounted on the top of waste containers 600, 610 and 620; the re-usable dirty item container 600 collects the items which can be cleaned and re-used such as metal forks, spoons, knives, plates, etc., the general waste container 610 collects items such as dirty napkins, one time use forks, spoons, knives, plates, etc.; the special waste container 620 collects items with unpleasant smells such as dirty diapers, hazardous items, etc.; the moving cart 650 is at the bottom, so the multiple function appliance 1 can be easily moved around the house.

FIG. 5 shows that the multiple function appliance is placed besides the bed 680 and the bed tray table 500 is set on the bed 680, the bed tray table 500 can be used as a dining table or a work table. Many attachments can be added to the multiple appliance 1 to provide more convenience for the patient, those attachments can include a bathroom tissue holder 700, a napkin box holder 710, a basket 720 (to hold small items such as medicine bottles, tea bags or other small items) on the cooling chamber door 320, and storage cabinets 730, or others. The bed tray table 500 can be rotated away from the bed if needed such as that the patient is going to sleep or doing other activities.

This multiple function appliance has no hot or sharp elements exposed to the patient so it is safe for the patient in the bed. With this multiple function appliance in place, the family member or the healthcare provider just stores the fresh prepared food, the sealed plastic eat-ready food packages, the cold preserved medicines or other items into the cooling chamber 300, stores other items in those attachments, the patient can take care of himself/herself as long as the patient has one arm and one hand function normally and his/her physical condition allows him/her to perform those activities; for some patients, adjustable beds are preferred. This will dramatically reduce the family member or the healthcare provider's work load, and stress, and the patient can also get some exercise, the family member can go to work without worrying about the patient at home and add those items which are consumed by the patient and empty the wastes when he/she has time later. The drawing of the multiple function appliance 1 in FIG. 1 is for the right hand person, a mirror image copy of the FIG. 1 can be used for the left hand person. Due to the nature of the application of this multiple function appliance, a lower power of microwave and a smaller refrigerator than normal household appliance are expected.

The 3-in-1 combination 800 shown in FIG. 6 of the water dispenser 20, the cooling chamber 300 of refrigerator, the heating chamber 400 of the microwave oven and the central operation unit 200 of this invention can also be placed in regular offices or apartments for personal use with great convenience, especially when the space is limited. A coffee maker such as Keurig k-cup type can be easily adapted to this invention, so if without the k-cup coffee pack in place it just releases the hot water.

Whereas the present invention has been described in particular relation to the drawings attached hereto, it should be understood that other and further modifications, apart from those shown or suggested herein, may be made within the spirit and scope of this invention.

What is claimed is:

1. A portable multiple function appliance combining: a hot and cold water dispenser, a refrigerator, a microwave oven, a bed tray table with a lamp, a central operation unit, three waste containers for three different waste categories and a moving cart.

2. The said central operation unit of the claim 1 contains an electronic circuit board which is responsible for the entire operation of the portable multiple function appliance in claim 1 with front panel which has an information display window and all the operation buttons, a cooling unit for the refrigerator, a magnetron and a waveguide for the microwave oven, water dispenser components, a plastic bag opener and a cup sitting area.

3. The said bed tray table with the said lamp in the claim 1 is mounted on a motor which is attached to the side of the said portable multiple function appliance and can be rotated by a motor and its height can be adjusted.

4. The said portable multiple function appliance in claim 1 has many attachments to hold various items according to the actual needs.
